(19) United States
(12) Patent Application Publication
(10) Pub. No.: US 2014/0232681 A1
(43) Pub. Date: Aug. 21, 2014

(54) TOUCH SENSING APPARATUS AND TOUCH SENSING METHOD THEREOF

(71) Applicant: Novatek Microelectronics Corp., Hsinchu (TW)

(72) Inventor: Yun-Hsiang Yeh, Hsinchu County (TW)

(21) Appl. No.: 13/944,899

(22) Filed: Jul. 18, 2013

(30) Foreign Application Priority Data
Feb. 20, 2013 (TW) 102105906

(51) Int. Cl. G06F 3/044

(52) U.S. Cl. CPC G06F 3/044
USPC 345/174

(57) ABSTRACT

A touch sensing apparatus includes a touch sensing panel and a touch controller. The touch sensing panel includes a plurality of sensing channels for receiving a plurality of driving signals and sensing a touch event according to the driving signals. In a sensing duration, the touch sensing panel is switched between at least two operation modes among a plurality of operation modes to sense the touch event. The touch controller is configured to determine the type of the touch event according to the sensing results of the touch sensing panel in the at least two operation modes. In addition, a touch sensing method used in the above-mentioned touch sensing apparatus is provided as well.

### CROSS-REFERENCE TO RELATED APPLICATION

This application claims the priority benefit of Taiwan application serial no. 102105906, filed on Feb. 20, 2013. The entirety of the above-mentioned patent application is hereby incorporated by reference herein and made a part of this specification.

### BACKGROUND OF THE DISCLOSURE

1. Field of the Disclosure

The disclosure generally relates to a sensing apparatus and a sensing method thereof, and more particularly, to a touch sensing apparatus and a touch sensing method thereof.

2. Description of Related Art

In today's information age, mankind has increasing dependence on electronic products, and notebook computer, mobile phone, personal digital assistant (PDA), digital walkman and other electronic products have become indispensable application tools of modern life and work. All the above-mentioned electronic products have an input interface for entering the instructions required by the user so that the internal system of electronic products can automatically perform this instructions. The most-wide applicable input interface device today includes keyboard and mouse.

For the user, using the traditional input interface such as keyboard and mouse will undoubtedly cause considerable inconvenience for some circumstances. In order to solve such problems, the relevant manufacturers began to dispose a touch input interface such as touch pad or touch panel on the electronic device, by which the function of the keyboard or mouse is substituted. In term of current touch input interface, the user mostly takes advantage of contact between a touch stylus and the touch input interface or induction phenomena through the finger of the user to take tap actions for selecting operations. For capacitive touch input interface, for example, the multi-points touching feature provides a more humanized operation mode so that people pay more attentions on the capacitive touch panel today.

In the traditional capacitive touch sensing method, it usually uses driving signals with a synchronous phase to drive the sensing channels. In this way, if, for example, only water or other overlays the touch sensing panel, there is no potential difference between the sensing channels at all, and thereby the water or other liquids is unable to produce capacitive effect, which can help avoiding a misjudgment by the touch sensing panel that a user may conducts touch operation at that time. However, such touch sensing method results in poor quality of sensed signal in certain touching circumstances and causes problems of no sensing and poor accuracy.

### SUMMARY OF THE DISCLOSURE

Accordingly, the disclosure is directed to a touch sensing apparatus able to advance the accuracy of touch sensing.

The disclosure is also directed to a touch sensing method able to advance the accuracy of touch sensing.

The disclosure provides a touch sensing apparatus, which includes a touch sensing panel and a touch controller. The touch sensing panel includes a plurality of sensing channels for receiving a plurality of driving signals and sensing a touch event according to the driving signals. In a sensing duration, the touch sensing panel is switched between at least two operation modes among a plurality of operation modes to sense the touch event. The touch controller is configured to determine the type of the touch event according to the sensing results of the touch sensing panel in the at least two operation modes.

In an embodiment of the disclosure, the operation modes include a first operation mode, a second operation mode and a third operation mode, the types of the touch event include a common ground touch situation, a floating touch situation and a liquid touch situation; in the first operation mode, the sensing channels, by configuration, are suitable to sense the common ground touch situation and the floating touch situation; in the second operation mode and the third operation mode, the sensing channels, by configuration, are suitable to sense the common ground touch situation and the liquid touch situation.

In an embodiment of the disclosure, in the first operation mode, the driving signals include at least one first pulse signal and a plurality of grounding signals, and the first pulse signal has a level between a first voltage level and a second voltage level.

In an embodiment of the disclosure, in the first operation mode, the being-sensing channel among the sensing channels receives the first pulse signal, and the not-being-sensing channels among the sensing channels receive the grounding signal.

In an embodiment of the disclosure, in the second operation mode, the driving signals include at least one first pulse signal and a plurality of second pulse signals, and the first pulse signal has a level between a first voltage level and a second voltage level, and the second pulse signals have levels between the first voltage level and a third voltage level.

In an embodiment of the disclosure, in the second operation mode, the being-sensing channel among the sensing channels receives the first pulse signal, and the not-being-sensing channels receive the second pulse signals.

In an embodiment of the disclosure, in the third operation mode, the driving signals include a plurality of first pulse signals and the first pulse signals have levels between a first voltage level and a second voltage level.

In an embodiment of the disclosure, in the third operation mode, the being-sensing channel and not-being-sensing channels among the sensing channels receive the first pulse signals.

In an embodiment of the disclosure, when determining the type of the touch event, the touch controller further determines position on the touch sensing panel where the touch event occurs at according to the sensing result of at least one among the at least two operation modes.

In an embodiment of the disclosure, in the sensing duration, the touch sensing panel switches between at least three operation modes among the operation modes to sense the touch event, the touch controller determines the type of the touch event according to the sensing results of the touch sensing panel in the at least three operation modes, and when determining the type of the touch event, the touch controller further determines the position on the touch sensing panel where the touch event occurs at according to the sensing result of at least one among the at least three operation modes.

The disclosure also provides a touch sensing method used for a touch sensing apparatus, and the apparatus includes a touch sensing panel. The touch sensing method includes following steps: in a sensing duration, switching to an operation mode among a plurality of operation modes; in the operation mode, receiving a plurality of driving signals, and sensing a touch event according to the driving signals; in the sensing duration, switching to another operation mode among a plurality of operation modes; in the another operation mode, receiving the driving signals, and sensing the touch event according to the driving signals; and determining the type of the touch event according to the sensing results of the operation mode and the another operation mode.

In an embodiment of the disclosure, the step of determining the type of the touch event according to the sensing results of the operation mode and the other operation mode includes: determining the position on the touch sensing panel where the touch event occurs at according to the sensing result of at least one among the operation mode and the another operation mode.

In an embodiment of the disclosure, the touch sensing method further includes following steps: in the sensing duration, switching to yet another operation mode among the operation modes; in the yet another operation mode, receiving the driving signals, and sensing the touch event according to the driving signals, in which the step of determining the type of the touch event further includes determining the type of the touch event according to the sensing result of the yet another operation mode; and determining the position on the touch sensing panel where the touch event occurs at according to the sensing result of at least one among the operation mode, the another operation mode and the yet another operation mode.

In an embodiment of the disclosure, the operation modes include a first operation mode, a second operation mode and a third operation mode, the types of the touch event include a common ground touch situation, a floating touch situation and a liquid touch situation; in the first operation mode, the touch sensing method is suitable to sense the common ground touch situation and the floating touch situation; in the second operation mode and the third operation mode, the touch sensing method is suitable to sense the common ground touch situation and the liquid touch situation.

In an embodiment of the disclosure, in the first operation mode, the driving signals include at least one first pulse signal and a plurality of grounding signals, and the first pulse signal has a level between a first voltage level and a second voltage level.

In an embodiment of the disclosure, in the second operation mode, the driving signals include at least one first pulse signal and a plurality of second pulse signals, and the first pulse signal has a level between a first voltage level and a second voltage level and the second pulse signals have levels between a first voltage level and a third voltage level.

In an embodiment of the disclosure, in the third operation mode, the driving signals include a plurality of first pulse signals and the first pulse signals have levels between a first voltage level and a second voltage level.

The disclosure further provides a touch sensing apparatus, which includes a touch sensing panel and a touch controller. The touch sensing panel includes a plurality of sensing channels configured to receive a plurality of driving signals in an operation mode and sense a touch event according to the driving signals. The touch controller is configured to determine the type of the touch event according to the sensing results of the sensing channels in the operation mode. In the operation mode, the driving signals are a plurality of pulse signals, and at least one pulse signal among the pulse signals is different from the rest pulse signals among the pulse signals.

In an embodiment of the disclosure, when determining the type of the touch event, the touch controller further determines the position on the touch sensing panel where the touch event occurs at according to the sensing result.

In an embodiment of the disclosure, the types of the touch event include a common ground touch situation, a floating touch situation and a liquid touch situation. In the operation mode, the sensing channels, by configuration, are suitable to sense the common ground touch situation and the liquid touch situation.

In an embodiment of the disclosure, in the operation mode, the being-sensing channel among the sensing channels receives the at least one pulse signal, and the not-being-sensing channels receive the rest pulse signals.

In an embodiment of the disclosure, the driving signals include at least one first pulse signal and a plurality of second pulse signals, the at least one first pulse signal is different from the second pulse signals, the first pulse signal has a level between a first voltage level and a second voltage level, and the second pulse signals have levels between the first voltage level and the third voltage level.

Based on the description above, in the exemplary embodiments of the disclosure, in the sensing duration, the touch sensing panel is switched between different operation modes to sense the touch event. The touch controller determines the type of the touch event and the position where the touch event occurs at according to the sensing results of the different operation modes so as to advance the accuracy of the touch sensing.

In order to make the features and advantages of the present disclosure more comprehensible, the present disclosure is further described in detail in the following with reference to the embodiments and the accompanying drawings.

### BRIEF DESCRIPTION OF THE DRAWINGS

FIG. 1 is a brief diagram of a touch sensing apparatus according to an exemplary embodiment of the disclosure.

FIG. 2A is a brief diagram of the touch sensing panel in FIG. 1.

FIG. 2B is a brief diagram of a touch sensing apparatus according to another exemplary embodiment of the disclosure.

FIG. 3A is a brief diagram showing the touch sensing panel in the first operation mode.

FIG. 3B is a chart showing the capacitance variation sensed by the touch sensing panel in the first operation mode for different touch situations.

FIG. 4A is a brief diagram showing the touch sensing panel in the second operation mode.

FIG. 4B is a chart showing the capacitance variation sensed by the touch sensing panel in the second operation mode for different touch situations.

FIG. 5A is a brief diagram showing the touch sensing panel in the third operation mode.

FIG. 5B is a chart showing the capacitance variation sensed by the touch sensing panel in the third operation mode for different touch situations.

FIG. 6 is a brief flowchart of a touch sensing method according to an exemplary embodiment of the disclosure.

FIG. 7 is a brief flowchart of a touch sensing method according to another exemplary embodiment of the disclosure.

FIG. 8 is a brief flowchart of a touch sensing method according to yet another exemplary embodiment of the disclosure.

FIG. 9 is a brief flowchart of a touch sensing method according to yet another exemplary embodiment of the disclosure.

FIG. 10 is a brief flowchart of a touch sensing method according to yet another exemplary embodiment of the disclosure.

### DESCRIPTION OF THE EMBODIMENTS

The relevant technical principles and the features and effects thereof are clearly depicted together with the accompanying drawings in the following depicted embodiments, which are used in examples only not to limit the disclosure, and which are allowed to form suitable combinations as a part of the disclosure as well. Note that some of expression words in whole the description of the disclosure (including the scope of claims) have certain interpretations. For example, the term ‘coupling’ can mean direct or indirect connection means, that is, if it is stated in the text that ‘the first device is coupled to the second device’, it should be interpreted as the first device can be directly connected to the second device or the first device can be indirectly connected to the second device through other devices or certain connection means. In addition, the term ‘signal’ can mean a current, a voltage, a charges, a temperature, data or any one or multiple signals.

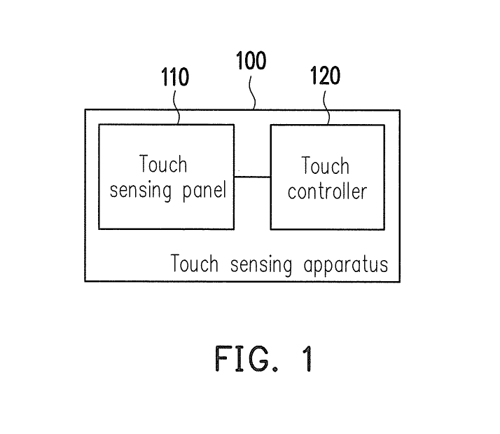

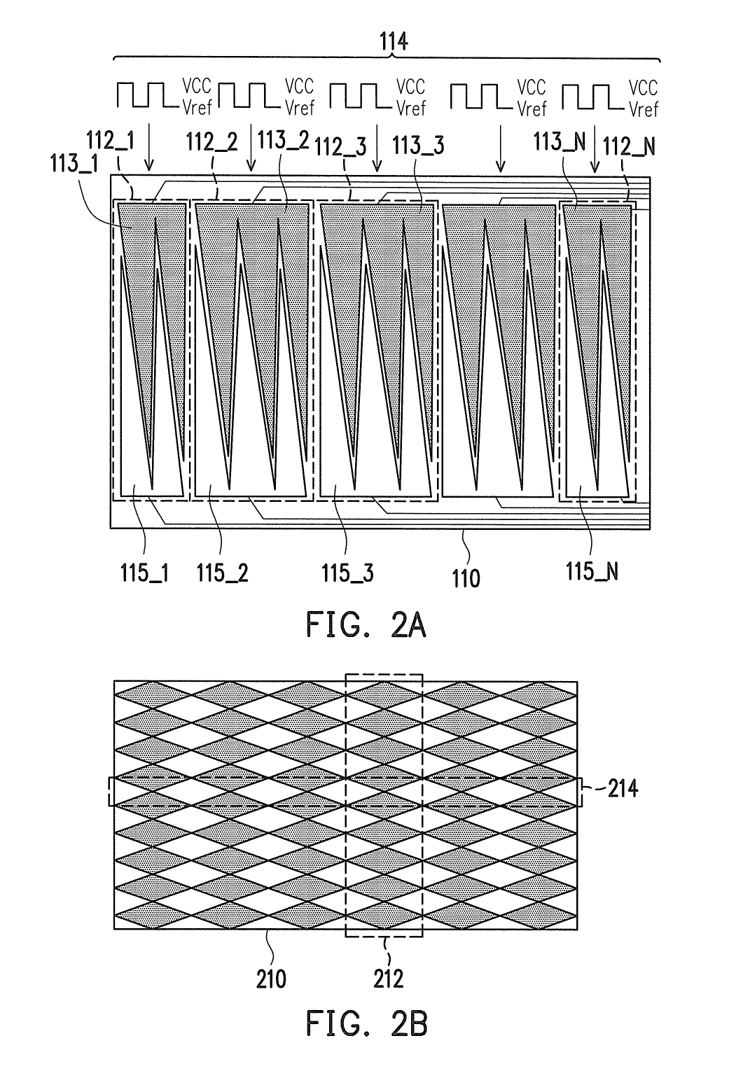

FIG. 1 is a brief diagram of a touch sensing apparatus according to an exemplary embodiment of the disclosure and FIG. 2A is a brief diagram of the touch sensing panel in FIG. 1. Referring to FIGS. 1 and 2A, in the exemplary embodiment, a touch sensing apparatus 100 includes a touch sensing panel 110 and a touch controller 120. The touch sensing panel 110 includes a plurality of sensing channels 112_1-112_N, in which each channel includes at least one scan electrode and at least one sensing electrode and the two kinds of electrodes are staggering arranged. The scan electrodes 113_1-113_N of the sensing channels 112_1-112_N are configured to receive a plurality of driving signals 114 provided by a touch driving circuit (not shown) so that the sensing electrodes 115_1-115_N can sense a touch event and produce sensed signals according to the driving signals 114. It should be noted that the electrode pattern of the touch sensing panel 110 in the exemplary embodiment does not limit the touch sensing method of the disclosure. FIG. 2B is a brief diagram of a touch sensing apparatus according to another exemplary embodiment of the disclosure. Referring to FIG. 2B, in the embodiment, the electrode pattern of a touch sensing panel 210 includes a plurality of scan electrodes 212 and sensing electrodes 214, both of which are arranged in an array but along two different directions. In short, the sensing channels in the embodiment can include a column of scan electrodes and lines of the corresponding sensing electrodes.

Referring to FIGS. 1 and 2A again, in the exemplary embodiment, the touch event includes, but not limited to, a common ground touch situation, a floating touch situation and a liquid touch situation. In the common ground touch situation, the user conducts touch sensing on the touch sensing panel 110 with a same state of the touch sensing apparatus 100, i.e., both are in grounded states. However, in comparison with the common ground touch situation, in the floating touch situation, the user is not in the grounded state. The liquid touch situation means a part of region on the touch sensing panel 110 is overlaid by, for example, water or other liquids, and at the time, the region overlaid by the liquid may affect the accuracy of touch sensing during the touch sensing by the user.

In order to advance the accuracy of touch sensing, in the sensing duration, the touch sensing panel 110 in the exemplary embodiment can be switched between a plurality of different operation modes for sensing the touch event, so that the touch controller 120 can determine the type of the touch event and calculate out the position on the touch sensing panel 110 where the touch event occurs at according to the sensing results of the touch sensing panel 110 in the different operation modes. Therefore, by using the touch sensing method with switching the touch sensing panel between a plurality of different operation modes can effectively increase the accuracy of touch sensing.

In the exemplary embodiment, the touch sensing panel 110 can be switched between at least two modes among a first operation mode, a second operation mode and a third operation mode. In following, some embodiments are used to describe the different operations of the touch sensing panel of the disclosure in different modes.

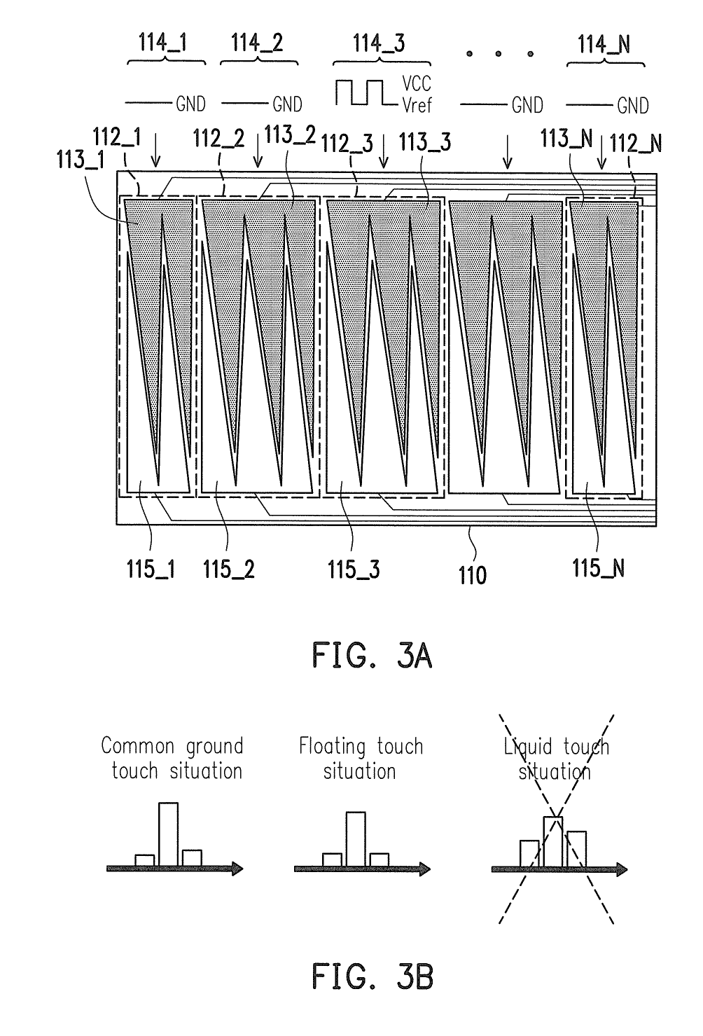

FIG. 3A is a brief diagram showing the touch sensing panel in the first operation mode and FIG. 3B is a chart showing the capacitance variation sensed by the touch sensing panel in the first operation mode for different touch situations. Referring to FIGS. 3A and 3B, a touch sensing panel 110 in the exemplary embodiment works in the first operation mode. In the sensing duration, the touch driving circuit would sequentially provide a plurality of driving signals 114_1-114_N to the scan electrodes 113_1-113_N along with the timing stream so that the sensing electrodes 113_1-113_N can conduct touch sensing. Thus, the sensing channels 112_1-112_N can be roughly divided into currently being-sensing channels and currently not-being-sensing channels. In FIG. 3A, the being-sensing channel is the sensing channel 112_3 as an example, while the rest sensing channels 112_1, 112_2, 112_4, . . . , and 112_N do not conduct sensing at the same time point, which the disclosure is not limited to.

In the first operation mode, the driving signals 114_1-114_N include a first pulse signal 114_3 and a plurality of grounding signals 114_1, 114_2, 114_4, . . . , and 114_N, in which the phase of the first pulse signal 114_3 is between a first voltage level VCC and a second voltage level Vref. In the embodiment, the being-sensing channel 112_3 receives the first pulse signal 114_3, while the not-being-sensing channels 112_1, 112_2, 112_4, . . . , and 112_N receive the grounding signals 114_1, 114_2, 114_4, . . . , and 114_N. As a result, at least one among the driving signals 114_1-114_N received by the sensing channels 112_1-112_N is different from the rest driving signals. In the mode, when the touch sensing panel 110 conducts sensing of the floating touch situation, except for the being-sensing channel 112_3, all the not-being-sensing channels 112_1, 112_2, 112_4, . . . , and 112_N are in the grounding state at the time. Therefore, in the floating touch situation, the sensing results of the touch sensing panel 110 are similar to the sensing results obtained in the common ground touch situation, i.e., the sensing channels where the touch event occurs at on the touch sensing panel 110 have higher capacitance variation in comparison with the adjacent sensing channels thereto where the touch event does not occur at, as shown by the common ground touch situation and the floating touch situation in FIG. 3B.

Thus, in the first operation mode, when the capacitance variations sensed by the sensing channels 112_1, 112_2, 112_4, . . . , and 112_N are higher than a preset threshold, the touch controller 120 can determine the corresponding touch positions on the touch sensing panel 110 where the touch event occurs at according to the sensing results. In other words, in the first operation mode, the sensing channels 112_1-112_N of the embodiment, by configuration, are suitable to sense the common ground touch situation and the floating touch situation.

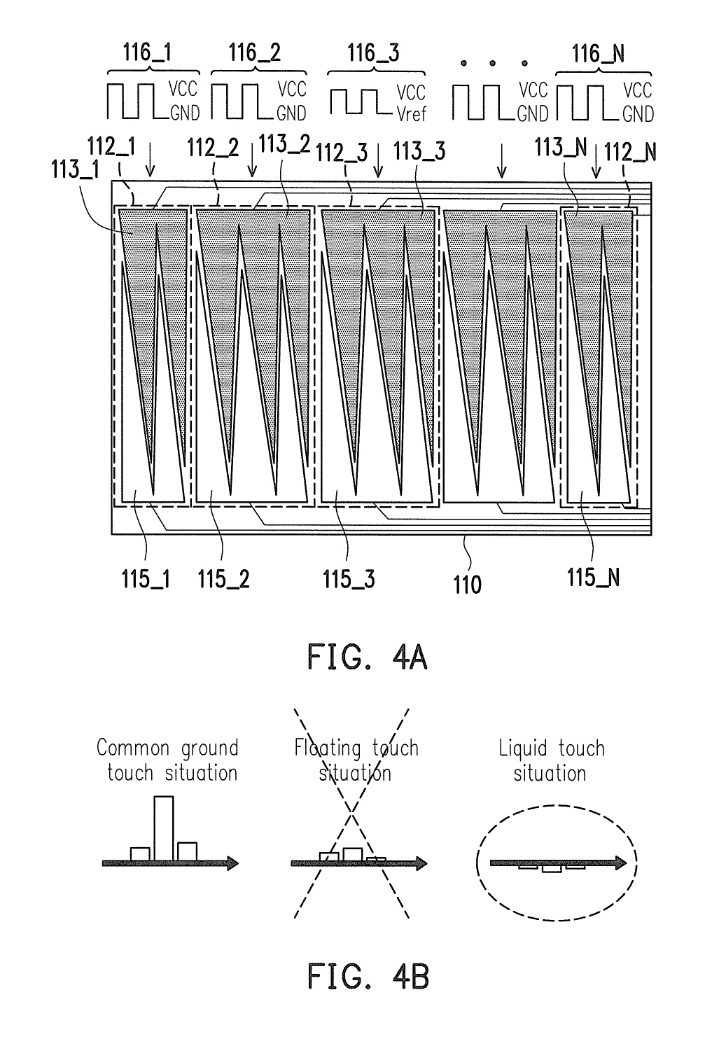

FIG. 4A is a brief diagram showing the touch sensing panel in the second operation mode and FIG. 4B is a chart showing the capacitance variation sensed by the touch sensing panel in the second operation mode for different touch situations. Referring to FIGS. 4A and 4B, in the second operation mode, the being-sensing channel 112_3 receives the first pulse signal 116_3, while the not-being-sensing channels 112_1, 112_2, 112_4, . . . , and 112_N receive the second pulse signals 116_1, 116_2, 116_4, . . . , and 116_N, in which the phases of the second pulse signals 116_1, 116_2, 116_4, . . . , and 116_N are between the first voltage level VCC and a third voltage level GND. As a result, at least one among the driving signals 116_1-116_N received by the sensing channels 112_1-112_N is different from the rest driving signals. In the mode, when the touch sensing panel 110 is conducting sensing of the liquid touch situation, except for the being-sensing channel 112_3, the not-being-sensing channels 112_1, 112_2, 112_4, . . . , and 112_N receive the second pulse signals 116_1, 116_2, 116_4, . . . , and 116_N. Therefore, during the charging phase in the liquid touch situation, all the not-being-sensing channels 112_1, 112_2, 112_4, . . . , and 112_N have a same phase without producing the capacitive effect. On the other hand, during back-charging the circuit chip or the capacitor, the being-sensing channel 112_3 has a level nearby the second voltage level Vref, while the not-being-sensing channels 112_1, 112_2, 112_4, . . . , and 112_N are in the third voltage level GND, so that the being-sensing channel 112_3 has current leakage, which causes a capacitance variation with negative phase, as shown by the liquid touch situation in FIG. 4B. In the second operation mode, since the not-being-sensing channels 112_1, 112_2, 112_4, . . . , and 112_N receive the second pulse signals 116_1, 116_2, 116_4, . . . , and 116_N instead of receiving the grounding signals, the sensing results during sensing the common ground touch situation and the floating touch situation have a gap therebetween.

Thus, in the second operation mode, when the capacitance variations sensed by the sensing channels 112_1-112_N are higher than the preset threshold, it can be determined the touch event is a common ground touch situation according to the sensing results, and the touch controller 120 can also calculate out the corresponding touch position on the touch sensing panel 110. In addition, the situation with a capacitance variation with negative phase means the touch event at the time belongs to the liquid touch situation. In other words, in the second operation mode, the sensing channels 112_1-112_N of the embodiment, by configuration, are suitable to sense the common ground touch situation and the liquid touch situation.

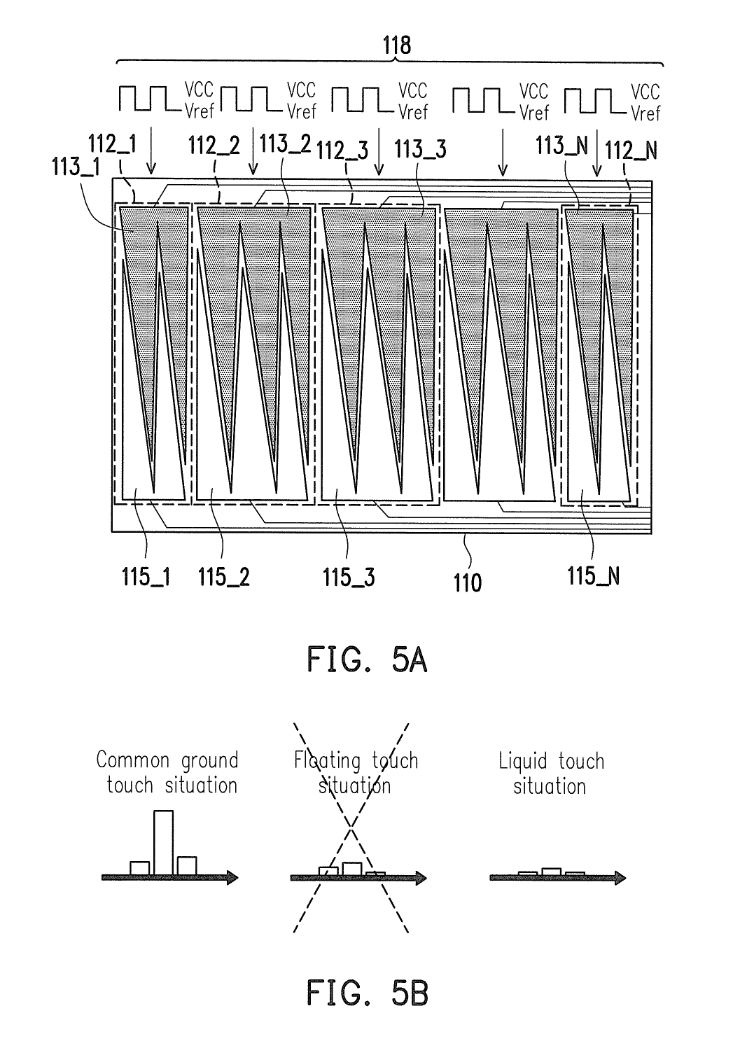

FIG. 5A is a brief diagram showing the touch sensing panel in the third operation mode and FIG. 5B is a chart showing the capacitance variation sensed by the touch sensing panel in the third operation mode for different touch situations. Referring to FIGS. 5A and 5B, in the third operation mode, regardless of the being-sensing channel 112_3 or the not-being-sensing channels 112_1, 112_2, 112_4, . . . , and 112_N, both receive the first pulse signal 118 with phases between the first voltage level VCC and the second voltage level Vref. In the mode, all the not-being-sensing channels 112_1, 112_2, 112_4, . . . , and 112_N have a same phase, so that no capacitive effect is produced in the liquid touch situation. On the other hand, during a charge-sharing phase, all the sensing channels 112_1-112_N have the phase nearby the second voltage level Vref, so that current leakage occurs, which less affects the accuracy of touch sensing by the liquid, as shown by the liquid touch situation in FIG. 4B. In addition, in the third operation mode, since all the sensing channels 112_1, 112_2, 112_4, . . . , and 112_N do not receive the grounding signals, the sensing results during sensing the common ground touch situation and the floating touch situation have a gap therebetween.

As a result, in the third operation mode, when the capacitance variations sensed by the sensing channels 112_1-112_N are higher than the preset threshold, the touch controller 120 can determine the touch event is a common ground touch situation according to the sensing results, and the touch controller 120 can also calculate out the corresponding touch position on the touch sensing panel 110. In other words, in the third operation mode, the sensing channels 112_1-112_N of the embodiment, by configuration, are suitable to sense the common ground touch situation and the liquid touch situation.

In the touch sensing method of the disclosure, the touch sensing panel 110 is switched between at least two modes among the above-mentioned three modes. Some embodiments are described in following to explain the operations of the touch sensing method of the disclosure for switching between different modes.

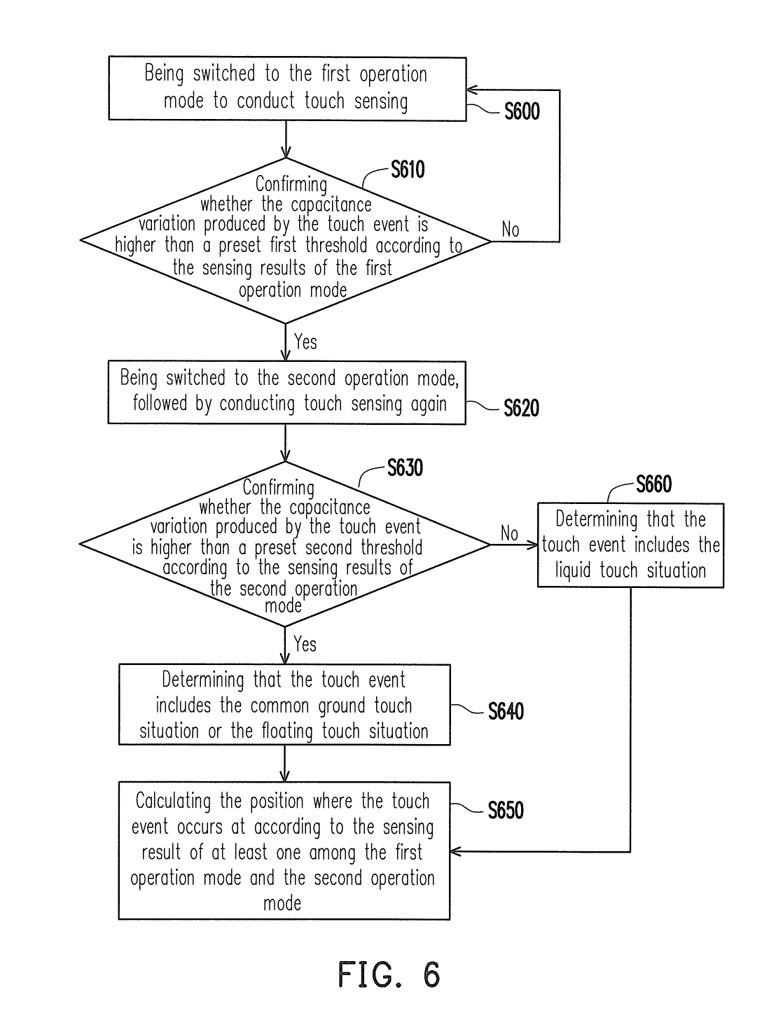

FIG. 6 is a brief flowchart of a touch sensing method according to an exemplary embodiment of the disclosure. Referring to FIGS. 1 and 6, in the touch sensing method of the exemplary embodiment, the touch sensing panel 110 is switched, for example, between a first operation mode and a second operation mode. First, in step S600, the touch sensing panel 110 is switched to the first operation mode to conduct touch sensing. At the time, the being-sensing channel receives a first pulse signal, while the not-being-sensing channels receive the grounding signals. Next, in step S610, the touch controller 120 confirms whether the capacitance variation produced by the corresponding touch event in the first operation mode is higher than a preset first threshold according to the sensing results of step S600. If the capacitance variation is higher than the first threshold, it means the touch event at the time includes the common ground touch situation or the floating touch situation, then, the touch sensing method goes to step S620 to switch the touch sensing panel 110 to the second operation mode, followed by conducting touch sensing again. At the time, the being-sensing channel receives the first pulse signal and the not-being-sensing channels receive the second pulse signals. If the capacitance variation is not higher than the first threshold, the touch sensing method goes back to step S600, followed by scanning again.

Then, in step S630, the touch controller 120 confirms whether the capacitance variation produced by the corresponding touch event in the second operation mode is higher than a preset second threshold according to the sensing results of step S620. If the capacitance variation is higher than the second threshold, the touch sensing method goes to step S640 and it is determined that the touch event at the time includes the common ground touch situation or the floating touch situation, i.e., the touch is produced by the finger of the user or a touch medium, for example, a touch stylus. If the capacitance variation is not higher than the second threshold, the touch sensing method goes to step S660, and it is determined that the touch event at the time includes the liquid touch situation, i.e., there is, for example, water or other liquids stays on the touch sensing panel 110, and a part of the region thereof is overlaid by water or other liquids.

Further, in step S650, the touch controller 120 calculates the position on the touch sensing panel 110 where the touch event occurs at according to the sensing result of at least one among the first operation mode and the second operation mode. For example, in the exemplary embodiment, if the touch event does not include the liquid touch situation, the touch controller 120 calculates the position on the touch sensing panel 110 where the touch event occurs at according to the sensing result of the first operation mode; on the contrary, if the touch event includes the liquid touch situation, the touch controller 120 calculates the position on the touch sensing panel 110 where the touch event occurs at according to the sensing result of the second operation mode so as to advance the accuracy of touch sensing.

It should be noted that, in the exemplary embodiment, it is assumed that the touch sensing panel 110 is switched to the first operation mode first, and then, switched to the second operation mode, but such a switching sequence is an example only, which the disclosure is not limited to. In some embodiments, the touch sensing panel 110 can be switched to the second operation mode first, followed by switching to the first operation mode for conducting touch sensing, which can advance the accuracy of touch sensing as well. In addition, the touch sensing panel 110 can be switched between the first operation mode, the second operation mode and a third operation mode too, described as follows.

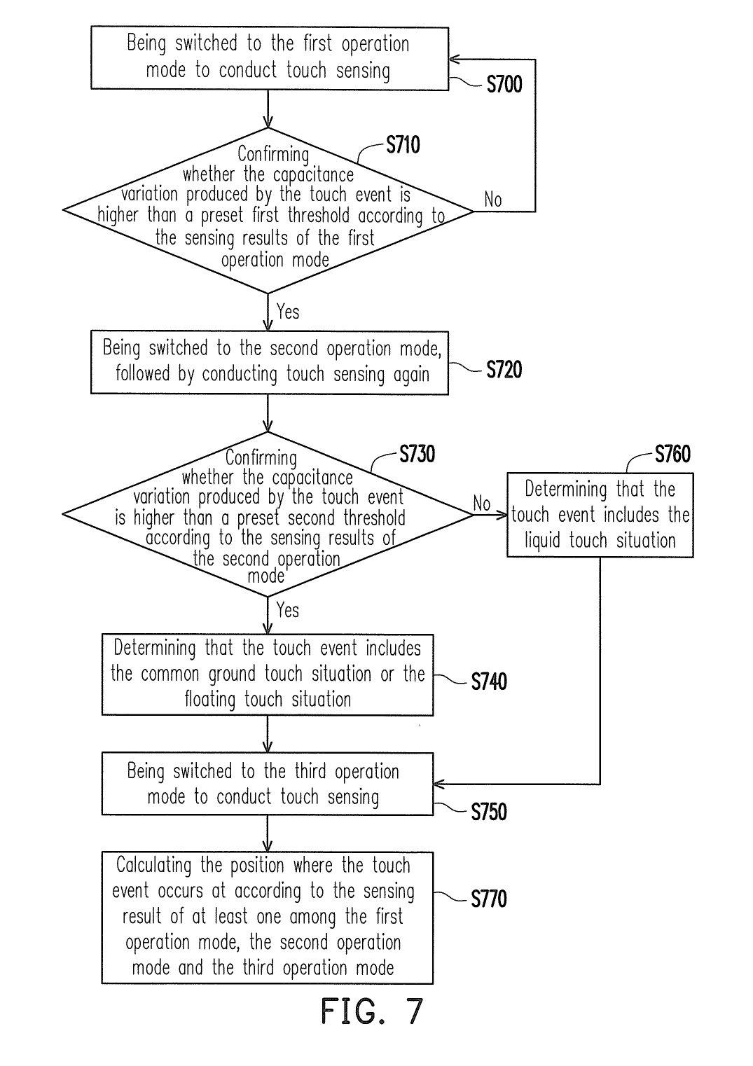

FIG. 7 is a brief flowchart of a touch sensing method according to another exemplary embodiment of the disclosure. Referring to FIGS. 1 and 7, in the touch sensing method of the exemplary embodiment, the touch sensing panel 110 is, for example, switched between the first operation mode, the second operation mode and the third operation mode. The touch sensing method of the exemplary embodiment is similar to the method flow of FIG. 6, except that after step S740 the touch sensing panel 110 is further switched to the third operation mode for conducting touch sensing to obtain the sensing results in the third operation mode, as shown by step S750. In step S770 therefore, the touch controller 120 would calculate the position on the touch sensing panel 110 where the touch event occurs at according to the sensing result of at least one among the first operation mode, the second operation mode and the third operation mode. For example, in the exemplary embodiment, if the touch event does not include the liquid touch situation, the touch controller 120 would calculate the position on the touch sensing panel 110 where the touch event occurs at according to the sensing result of the first operation mode. On the contrary, if the touch event includes the liquid touch situation, the touch controller 120 would calculate the position on the touch sensing panel 110 where the touch event occurs at according to the sensing result of the third operation mode so as to advance the accuracy of touch sensing.

It should be noted that in the exemplary embodiment the touch sensing panel 110 is, for example, finally switched to the third operation mode, which the disclosure is not limited to. In some embodiments, the touch sensing panel 110 can be switched to the third operation mode first, followed by being switched to the first operation mode and then the second operation mode or can be switched between the first operation mode and the second operation mode but adding the third operation mode, which can advance the accuracy of touch sensing as well. In other words, the disclosure does not limit the switching sequence of the operation modes. In addition, the touch sensing panel 110 can be restricted to be switched between the third operation mode and the first operation mode, as description as follows.

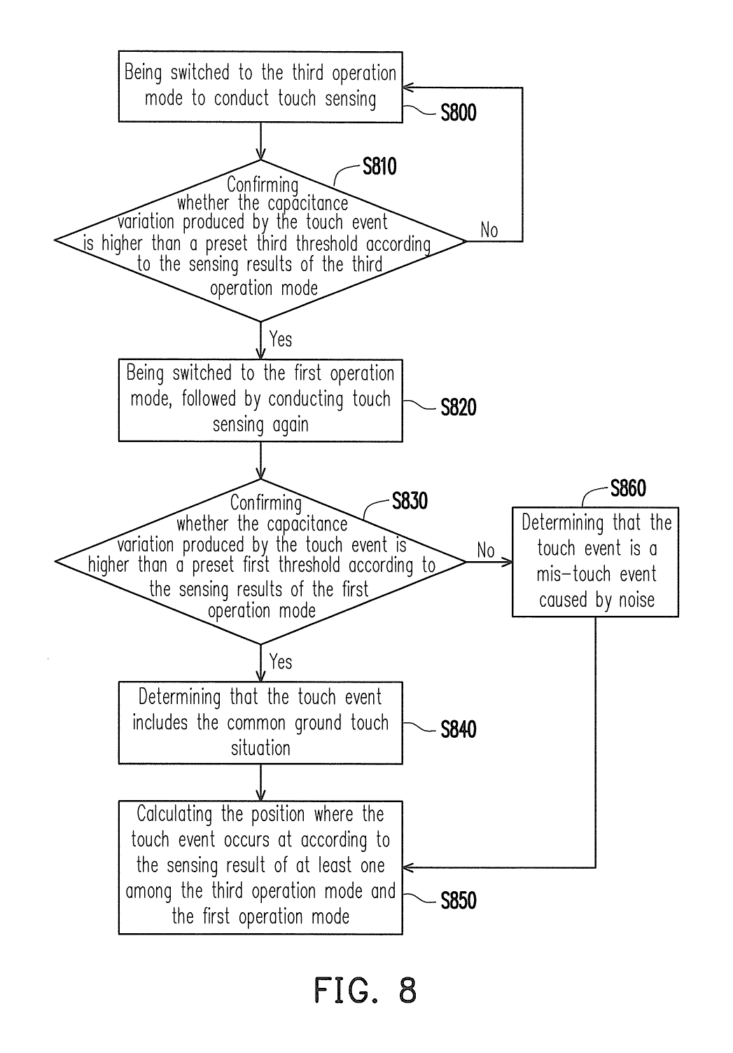

FIG. 8 is a brief flowchart of a touch sensing method according to yet another exemplary embodiment of the disclosure. Referring to FIGS. 1 and 8, in the touch sensing method of the exemplary embodiment, the touch sensing panel 110 is, for example, switched between the third operation mode and the first operation mode. In step S800, the touch sensing panel 110 is switched to the third operation mode first for conducting touch sensing. At the time, regardless of the being-sensing channel or the not-being-sensing channels, they all receive the first pulse signal. Then in step S810, the touch controller 120 would confirm whether the capacitance variation produced by the corresponding touch event in the third operation mode is higher than a preset third threshold according to the sensing results of step S800. If the capacitance variation is higher than the third threshold, it means the touch event at the time includes the common ground touch situation, then, the touch sensing method goes to step S820 to switch the touch sensing panel 110 to the first operation mode, followed by conducting touch sensing again. At the time, the being-sensing channel receives the first pulse signal and the not-being-sensing channels receive the second pulse signals. If the capacitance variation is not higher than the third threshold, the touch sensing method goes back to step S800, followed by scanning again.

Then, in step S830, the touch controller 120 confirms whether the capacitance variation produced by the corresponding touch event in the first operation mode is higher than a preset first threshold according to the sensing results of step S820. If the capacitance variation is higher than the first threshold, the touch sensing method goes to step S840 and it is determined that the touch event at the time includes the common ground touch situation, i.e., the touch is produced by the finger of the user or a touch medium, for example, a touch stylus. If the capacitance variation is not higher than the first threshold, the touch sensing method goes to step S860, and it is determined that the touch event at the time is a mis-touch event caused by noise.

Further, in step S850, the touch controller 120 calculates the position on the touch sensing panel 110 where the touch event occurs at according to the sensing result of at least one among the third operation modes and the first operation mode. For example, in the exemplary embodiment, the touch controller 120 calculates the position on the touch sensing panel 110 where the touch event occurs at according to the sensing result of the third operation mode so as to advance the accuracy of touch sensing.

It should be noted that, in the exemplary embodiment, it is assumed that the touch sensing panel 110 is switched to the third operation mode first, and then, switched to the first operation mode, but such a switching sequence is an example only, which the disclosure is not limited to. In some embodiments, the touch sensing panel 110 can be switched to the first operation mode first, followed by switching to the third operation mode for conducting touch sensing, which can advance the accuracy of touch sensing as well.

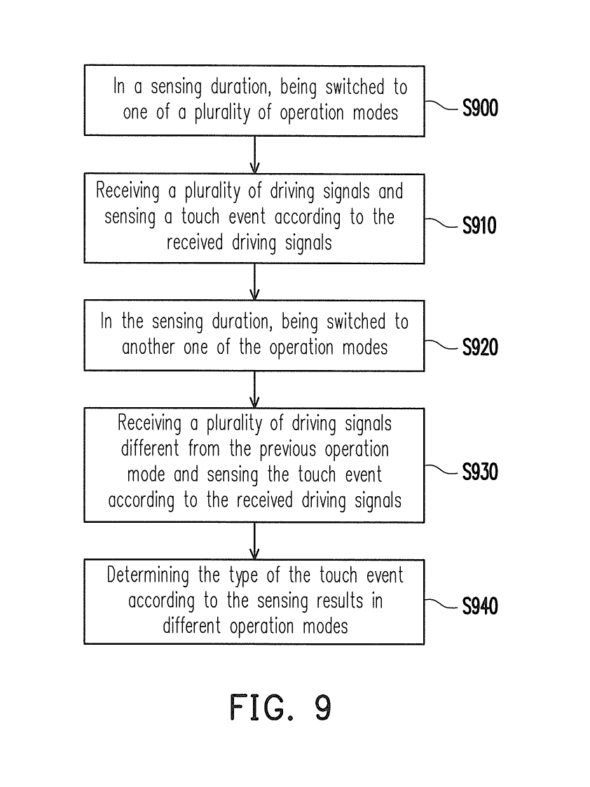

FIG. 9 is a brief flowchart of a touch sensing method according to yet another exemplary embodiment of the disclosure. Referring to FIGS. 1 and 9, the touch sensing method of the exemplary embodiment is suitable for, for example, the touch sensing apparatus of FIG. 1. First in step S900, in a sensing duration, the touch sensing panel 110 is switched to one of a plurality of operation modes. Next in step S910, the touch sensing panel 110 receives a plurality of driving signals in the operation mode and senses a touch event according to the received driving signals. Then in step S920, in the sensing duration, the touch sensing panel 110 is switched to another one of the operation modes. Further in step S930, the touch sensing panel 110 in the another operation mode receives a plurality of driving signals different from the previous operation mode and senses the touch event according to the received driving signals. Moreover in step S940, touch controller 120 determines the type of the touch event according to the sensing results in different operation modes. The step includes determining the position on the touch sensing panel where the touch event occurs at according to the sensing result in at least one among the different operation modes.

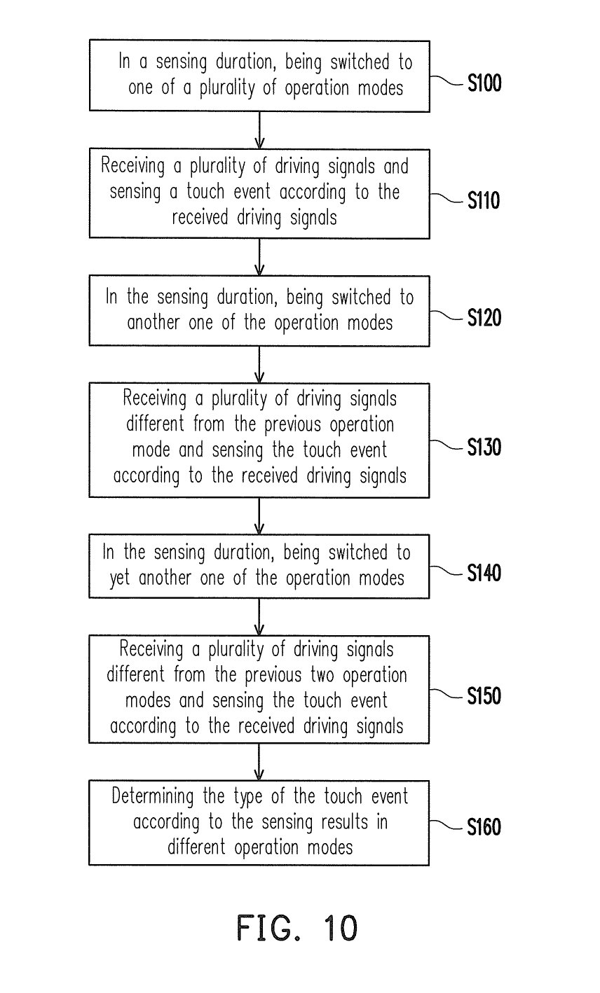

FIG. 10 is a brief flowchart of a touch sensing method according to yet another exemplary embodiment of the disclosure. Referring to FIGS. 1 and 10, the touch sensing method of the exemplary embodiment is suitable for, for example, the touch sensing apparatus of FIG. 1. First in step S100, in a sensing duration, the touch sensing panel 110 is switched to one of a plurality of operation modes. Next in step S110, the touch sensing panel 110 receives a plurality of driving signals in the operation mode and senses a touch event according to the received driving signals. Then in step S120, in the sensing duration, the touch sensing panel 110 is switched to the another one of the operation modes. Further in step S130, the touch sensing panel 110 receives a plurality of driving signals in the another operation mode other than the previous operation mode and senses the touch event according to the received driving signals. Moreover in step S140, in the sensing duration, the touch sensing panel 110 is switched to yet another operation mode among the operation modes. Then in step S150, the touch sensing panel 110 in the yet another operation mode receives the driving signals different from the previous two operation modes and senses the touch event according to the sensing results. Finally in step S160, the touch controller 120 determines the type of the touch event according to the sensing results in different operation modes, and the step includes determining the position on the touch sensing panel where the touch event occurs at according to the sensing result in at least one among the different operation modes.

In addition, the touch sensing methods in the exemplary embodiments of FIGS. 9 and 10, can get the sufficient instructions, advices and descriptions in the first to eighth embodiments to follow, which are omitted for simplicity.

In summary, in the exemplary embodiments of the disclosure, in the sensing duration, the touch sensing panel is switched between different operation modes to sense the touch event. The different operation modes, by configuration, receive different driving signals so as to suit sensing different touch situations. As a result, the touch controller can determine the type of the touch event and the position where the touch event occurs at according to the sensing results of the different operation modes so as to advance the accuracy of the touch sensing.

It will be apparent to those skilled in the art that the descriptions above are several preferred embodiments of the disclosure only, which does not limit the implementing range of the disclosure. Various modifications and variations can be made to the structure of the disclosure without departing from the scope or spirit of the disclosure. The claim scope of the disclosure is defined by the claims hereinafter.

What is claimed is:

1. A touch sensing apparatus, comprising:
a touch sensing panel, comprising:
a plurality of sensing channels, configured to receive a plurality of driving signals and sense a touch event according to the driving signals, wherein in a sensing duration, the touch sensing panel is switched between at least two operation modes among a plurality of operation modes to sense the touch event; and
a touch controller, configured to determine a type of the touch event according to sensing results of the touch sensing panel in the at least two operation modes.

2. The touch sensing apparatus as claimed in claim 1, wherein the operation modes comprise a first operation mode, a second operation mode and a third operation mode, the type of the touch event comprise a common ground touch situation, a floating touch situation and a liquid touch situation; in the first operation mode, the sensing channels are configured to sense the common ground touch situation and the floating touch situation; in the second operation mode and the third operation mode, the sensing channels are configured to sense the common ground touch situation and the liquid touch situation.

3. The touch sensing apparatus as claimed in claim 2, wherein in the first operation mode, the driving signals comprise at least one first pulse signal and a plurality of grounding signals, and the first pulse signal has a level between a first voltage level and a second voltage level.

4. The touch sensing apparatus as claimed in claim 3, wherein in the first operation mode, at least one being-sensing channel among the sensing channels receives the first pulse signal, and the not-being-sensing channels among the sensing channels receive the grounding signal.

5. The touch sensing apparatus as claimed in claim 2, wherein in the second operation mode, the driving signals comprise at least one first pulse signal and a plurality of second pulse signals, and the first pulse signal has a level between a first voltage level and a second voltage level, and the second pulse signals have levels between the first voltage level and a third voltage level.

6. The touch sensing apparatus as claimed in claim 5, wherein in the second operation mode, the being-sensing channel among the sensing channels receives the first pulse signal, and the not-being-sensing channels receive the second pulse signals.

7. The touch sensing apparatus as claimed in claim 2, wherein in the third operation mode, the driving signals comprise a plurality of first pulse signals and the first pulse signals have levels between a first voltage level and a second voltage level.

8. The touch sensing apparatus as claimed in claim 7, wherein in the third operation mode, the being-sensing channel and the not-being-sensing channels among the sensing channels receive the first pulse signals.

9. The touch sensing apparatus as claimed in claim 2, wherein when determining the type of the touch event, the touch controller further determines a position on the touch sensing panel where the touch event occurs at according to a sensing result of at least one among the at least two operation modes.

10. The touch sensing apparatus as claimed in claim 2, wherein in the sensing duration, the touch sensing panel switches between at least three operation modes among the operation modes to sense the touch event, the touch controller determines the type of the touch event according to the sensing results of the touch sensing panel in the at least three operation modes, and when determining the type of the touch event, the touch controller further determines the position on the touch sensing panel where the touch event occurs at according to a sensing result of at least one among the at least three operation modes.

11. A touch sensing method, configured to a touch sensing apparatus comprising a touch sensing panel; the touch sensing method comprising:
in a sensing duration, switching to an operation mode among a plurality of operation modes;
in the operation mode, receiving a plurality of driving signals, and sensing a touch event according to the driving signals;
in the sensing duration, switching to another operation mode among a plurality of operation modes;
in the another operation mode, receiving the driving signals, and sensing the touch event according to the driving signals; and
determining a type of the touch event according to sensing results of the operation mode and the another operation mode.

12. The touch sensing method as claimed in claim 11, wherein the step of determining the type of the touch event according to the sensing results of the operation mode and the another operation mode comprises:
determining a position on the touch sensing panel where the touch event occurs at according to the sensing result of at least one among the operation mode and the another operation mode.

13. The touch sensing method as claimed in claim 11, further comprising:
in the sensing duration, switching to yet another operation mode among the operation modes;
in the yet another operation mode, receiving the driving signals, and sensing the touch event according to the driving signals, wherein the step of determining the type of the touch event further comprises determining the type of the touch event according to a sensing result of the yet another operation mode; and
determining the position on the touch sensing panel where the touch event occurs at according to the sensing result of at least one among the operation mode, the another operation mode and the yet another operation mode.

14. The touch sensing method as claimed in claim 11, wherein the operation modes comprise a first operation mode, a second operation mode and a third operation mode, the types of the touch event comprise a common ground touch situation, a floating touch situation and a liquid touch situation; in the first operation mode, the touch sensing method is suitable to sense the common ground touch situation and the floating touch situation; in the second operation mode and the third operation mode, the touch sensing method is suitable to sense the common ground touch situation and the liquid touch situation.

15. The touch sensing method as claimed in claim 14, wherein in the first operation mode, the driving signals comprise at least one first pulse signal and a plurality of grounding signals, and the first pulse signal has a level between a first voltage level and a second voltage level.

16. The touch sensing method as claimed in claim 14, wherein in the second operation mode, the driving signals comprise at least one first pulse signal and a plurality of second pulse signals, and the first pulse signal has a level between a first voltage level and a second voltage level and the second pulse signals have levels between a first voltage level and a third voltage level.

17. The touch sensing method as claimed in claim 14, wherein in the third operation mode, the driving signals comprise a plurality of first pulse signals and the first pulse signals have levels between a first voltage level and a second voltage level.

18. A touch sensing apparatus, comprising:
a touch sensing panel, comprising:
a plurality of sensing channels, configured to receive a plurality of driving signals in an operation mode and sense a touch event according to the driving signals; and
a touch controller, configured to determine the type of the touch event according to a sensing result of the sensing channels in the operation mode,
wherein in the operation mode, the driving signals are a plurality of pulse signals, and at least one pulse signal among the pulse signals is different from rest pulse signals among the pulse signals.

19. The touch sensing apparatus as claimed in claim 18, wherein when determining the type of the touch event, the touch controller further determines position on the touch sensing panel where the touch event occurs at according to the sensing result.

20. The touch sensing apparatus as claimed in claim 18, wherein the types of the touch event comprise a common ground touch situation, a floating touch situation and a liquid touch situation; in the operation mode, the sensing channels are configured to sense the common ground touch situation and the liquid touch situation.

21. The touch sensing apparatus as claimed in claim 18, wherein in the operation mode, the being-sensing channel among the sensing channels receives the at least one pulse signal, and the not-being-sensing channels receive the rest pulse signals.

22. The touch sensing apparatus as claimed in claim 18, wherein the driving signals comprise at least one first pulse signal and a plurality of second pulse signals, the at least one first pulse signal is different from the second pulse signals, the first pulse signal has a level between a first voltage level and a second voltage level, and the second pulse signals have levels between the first voltage level and the third voltage level.
